(19) United States
(12) Patent Application Publication
(10) Pub. No.: US 2024/0100693 A1
(43) Pub. Date: Mar. 28, 2024

(54) USING EMBEDDINGS, GENERATED USING ROBOT ACTION MODELS, IN CONTROLLING ROBOT TO PERFORM ROBOTIC TASK

(71) Applicant: GOOGLE LLC, Mountain View, CA (US)

(72) Inventors: Daniel Ho, Fremont, CA (US); Eric Jang, Cupertino, CA (US); Mohi Khansari, San Carlos, CA (US); Yu Qing Du, Berkeley, CA (US); Alexander A. Alemi, Kissimmee, FL (US)

(21) Appl. No.: 18/102,053

(22) Filed: Jan. 26, 2023

Related U.S. Application Data
(60) Provisional application No. 63/303,912, filed on Jan. 27, 2022.

(51) Int. Cl. B25J 9/16

(52) U.S. Cl. CPC B25J 9/163; B25J 9/1653; B25J 9/1697; B25J 9/162

(57) ABSTRACT

Some implementations relate to using trained robotic action ML models in controlling a robot to perform a robotic task. Some versions of those implementations include (a) a first modality robotic action ML model that is used to generate, based on processing first modality sensor data instances, first predicted action outputs for the robotic task and (b) a second modality robotic action ML model that is used to generate, in parallel and based on processing second modality sensor data instances, second predicted action outputs for the robotic task. In some of those versions, respective weights for each pair of the first and second predicted action outputs are dynamically determined based on analysis of embeddings generated in generating the first and second predicted action outputs. A final predicted action output, for controlling the robot, is determined based on the weights.

### BACKGROUND

Various machine learning based approaches to robotic control have been proposed. For example, a machine learning model (e.g., a deep neural network model) can be trained that can be utilized to process images from vision component(s) of a robot and to generate, based on the processing, predicted output(s) that indicate robotic action(s) to implement in performing a robotic task. Some of those approaches train the machine learning model using training data that is based only on data from real-world physical robots. However, these and/or other approaches can have one or more drawbacks. For example, generating training data based on data from real-world physical robots requires heavy usage of one or more physical robots in generating data for the training data. This can be time-consuming (e.g., actually operating the real-world physical robots requires a large quantity of time), can consume a large amount of resources (e.g., power required to operate the robots), can cause wear and tear to the robots being utilized, can cause safety concerns, and/or can require a great deal of human intervention.

In view of these and/or other considerations, use of robotic simulators has been proposed to generate simulated data that can be utilized in generating simulated data. The generated simulated data can be utilized in training and/or validating of the machine learning models. Such simulated data can be utilized as a supplement to, or in lieu of, real-world data.

However, there is often a meaningful “reality gap” that exists between real robots and simulated robots (e.g., physical reality gap) and/or between real environments and simulated environments simulated by a robotic simulator (e.g., visual reality gap). This can result in generation of simulated data that does not accurately reflect what would occur in a real environment. This can affect performance of machine learning models trained on such simulated data and/or can require a significant amount of real-world data to also be utilized in training to help mitigate the reality gap. Additionally or alternatively, this can result in generation of simulated validation data that indicates a trained machine learning model is robust and/or accurate enough for real-world deployment, despite this not being the case in actuality.

Various techniques have been proposed to address the visual reality gap. Some of those techniques randomize parameters of a simulated environment (e.g., textures, lighting, cropping, and camera position), and generate simulated images based on those randomized parameters. Such techniques are referenced as “domain randomization”, and theorize that a model trained based on training instances that include such randomized simulated images will be better adapted to a real-world environment (e.g., since the real-world environment may be within a range of these randomized parameters). However, this randomization of parameters requires a user to manually define which parameters of the simulated environment are to be randomized.

Some other techniques are referenced as “domain adaptation”, where the goal is to learn features and predictions that are invariant to whether the inputs are from simulation or the real world. Such domain adaptation techniques include utilizing a Generative Adversarial Network (“GAN”) model and/or a Cycle Generative Adversarial Network (“CycleGAN”) model to perform pixel-level image-to-image translations between simulated environments and real-world environments. For example, a simulation-to-real model from a GAN can be used to transform simulated images, from simulated data, to predicted real images that more closely reflect a real-world, and training and/or validation performed based on the predicted real images. Although both GAN models and CycleGAN models produce more realistic adaptations for real-world environments, they are pixel-level only (i.e., they only adapt the pixels of images provided to the machine learning model) and/or can still lead to a meaningful reality gap.

### SUMMARY

Some implementations disclosed herein relate to training of robotic action machine learning (ML) model(s) for use in controlling a robot to perform robotic task(s). Such robotic task(s) can include, for example, door opening, door closing, drawer opening, drawer closing, picking up an object, placing an object, and/or other robotic task(s). Some implementations additionally or alternatively relate to using trained robotic action ML model(s) in controlling the robot to perform robotic task(s) for which the robotic action ML model(s) are trained.

Some of the implementations that relate to training of robotic action ML model(s) more particularly relate to mitigating the reality gap through feature-level domain adaptation during training of the robotic action machine learning (ML) model(s). Some of those implementations utilize a Variational informational Bottleneck (VIB) objective during training of at least initial layers of an action ML model. The initial layers of the action ML model can be an encoder and are used in processing a corresponding sensor data instance (e.g., an RGB image or a depth image) to generate a corresponding embedding or encoding of the sensor data instance. In various implementations, the generated embedding can be a stochastic embedding that parametrizes a distribution. As one example, the stochastic embedding can parameterize the means and covariances of a multivariate distribution over possible embeddings. Additional layers of the robotic action ML model can be a decoder and are used to process the corresponding embedding, optionally along with other data (e.g., robot state data), to generate a corresponding predicted action output. For example, sampling of the distribution, parameterized by the stochastic embedding, can be performed and the resulting embedding(s) from the sampling can be processed, using the additional layers of the robotic action ML model, to generate the predicted action output(s). For instance, a single embedding can be selected from the sampling and used to generate a single predicted action output. As another instance, N embeddings can be selected from the sampling, each used to generate a corresponding one of N disparate predicted action outputs, and an average (or other combination) of the N disparate prediction action outputs determined as the predicted action output. The sampling can be, for example, probability based and guided by the distribution defined by the stochastic embedding. A corresponding predicted action output, generated by processing the corresponding embedding using the additional layers, indicates a prediction of how component(s) of the robot should be controlled in an iteration of attempting performance of a robotic task. Accordingly, the robotic action ML model, once trained, can be used to control a robot during attempting performance of a robotic task by using the ML model to process a sequence of sensor data instances, generated by sensor(s) of a robot, and generate a sequence of predicted action output(s)—at least some of which can be used in controlling the robot in a corresponding iteration.

The VIB objective that can be utilized during training encourages, for each training input (e.g., a corresponding sensor data instance of an imitation learning training example), the corresponding embedding (e.g., stochastic embedding), that is generated using the initial layers, to have low mutual information with the training input. The VIB objective can further simultaneously encourage, for each training input, that the predicted action output generated based on processing the training input has high mutual information with the target training output (e.g., a ground truth robotic action of an imitation learning training example). Put another way, the VIB objective can simultaneously seek to achieve low mutual information between generated embeddings (generated as intermediate output of the action ML model) and their corresponding training inputs, while encouraging a low supervised loss for predicted action outputs (generated as final output of the action ML model). Accordingly, a VIB objective can utilize a loss that is a function of supervised loss(es) and a function of a representation of the mutual information between generated embedding(s) and their corresponding input(s).

The representation of the mutual information can be, for example, a VIB rate of the embedding. The VIB rate of an embedding can be, for example, a Kullback-Leibler divergence (e.g., in nats) of the state-posterior (e.g., the embedding) from the state-prior (e.g., the sensor data instance on which the embedding is generated). The representation of the mutual information can be weighted by a factor that controls the bottlenecking tradeoff. More formally, given an input source X (e.g., sensor data instance), a stochastic embedding Z (e.g., generated using the initial layers), and a target variable Y (e.g., a ground truth action output from an imitation learning episode), the VIB objective optimizes for a stochastic embedding Z that is maximally predictive of Y while being a compressed representation of X. One non-limiting example of an equation representation of a VIB objective is

$$\frac{1}{N} {\sum }_{n = 1}^{N} {𝔼}_{z \sim p ( 𝓏 \vert {x}_{n}} [ log q ( {𝓎}_{n} \vert 𝓏 ) - β log \frac{p ( 𝓏 \vert {x}_{n} )}{r ( 𝓏 )} ]$$

where p(z|x) is an encoder, q( [symbol] |z) is a variational approximation to p( [symbol] |z)=∫dx p( [symbol] |x)p(z|x)p(x)/p(z), r(z) is a variational approximation of p(z)=∫dx p(z|x)p(x), and N is the number of training examples.

Further, one non-limiting example of a decomposition of a training loss that can be utilized, for a singled input image s, in a VIB objective is

$$ℒ = {\underbrace{{𝔼}_{𝓏 \sim p ( 𝒵 \vert S ) [ - log q ( a \vert 𝓏 ) ]}}}_{{ℒ}_{BC}} + β {\underbrace{{𝔼}_{𝓏 \sim p ( 𝒵 \vert S ) [ log \frac{p ( 𝓏 \vert s )}{r ( 𝓏 )} ]}}}_{{ℒ}_{KL}}$$

where p(z|s) is a stochastic encoder, q(a|z) is an action decoder, the first term [symbol] _{BC} is the behavior cloning loss, and the second term [symbol] _{KL} is the rate, which can be equivalent to D_{KL}[p(z|x)∥r(z)]≥I(X; Z). The second term is weighted by β and controls the bottlenecking tradeoff.

Accordingly, the VIB objective can encourage generation of embeddings that “forget” aspects of a corresponding sensor data instance that are irrelevant to accurate prediction of robot actions, while having the embeddings reflect aspects of a corresponding sensor data instance that are predictive of a correctly predicted action output. This can encourage the initial layers to be trained such that the impact of the domain (e.g., real vs. simulated) of a sensor data instance is lessened in generating an embedding using the initial layers, while the impact of task-relevant features of the sensor data instance is increased in generating the embedding. Put another way, using the VIB objective during training can result in generation of a stochastic embedding and/or an embedding that extracts relevant information needed to robustly predict a robotic action based on the sensor data instance, while mitigating extraction of domain-dependent information (e.g., information that is dependent on whether the sensor data instance is real or simulated).

In these and other manners, the VIB objective can, when utilized during training, enable utilization of simulated training data (e.g., simulated imitation episodes) while mitigating the reality gap present in such simulated training data. Accordingly, utilization of the VIB objective can result in generation of a stochastic embedding, by processing a simulated sensor data instance using the initial layers, that will be similar to (or even the same as in some situations) a stochastic embedding generated by processing a real image counterpart. Put another way, instead of utilizing only input-level domain adaptation where simulated sensor data instances are translated into predicted real counterparts before being used for training, implementations disclosed herein seek to achieve feature-level domain adaptation so that simulation and real counterpart sensor data instances result in generation of similar embeddings when processed using the action ML model. Such feature-level domain adaptation mitigates the reality gap, enabling utilization of simulated data in training and/or validating the model, while ensuring accuracy and/or robustness of the trained action ML model when deployed on a real-world robot. For example, such feature-level domain adaptation enables the action ML model to be trained at least in part on simulated data, while ensuring the trained action ML model is robust and/or accurate when deployed on a real-world robot. As another example, such feature-level domain adaptation additionally or alternatively enables the action ML model to be validated based on simulated data, while ensuring the validation accurately reflects whether the trained action ML model is robust and/or accurate enough for real-world use.

As referenced above, the VIB objective can seek to minimize supervised losses generated based on a supervision signal. In various implementations, imitation learning can be utilized where the supervision signals are ground truth actions from a human demonstration of the robotic task. For example, the demonstration can be via virtual reality or augmented reality based control of a real or simulated robot, or via physical kinesthetic control of a real robot. In such an example, the supervised loss can be a behavior cloning loss such as a Huber loss between predicted and demonstrated actions. As another example, reinforcement learning can additionally or alternatively be utilized where the supervision signals are sparse rewards generated according to a reward function.

In various implementations, multiple action ML models are trained and subsequently utilized in controlling a robot. Each of the multiple action ML models can be trained and used to process a corresponding sensor data instance that is of a modality that is distinct from modality/modalities for which all other of the multiple action ML models are trained and used. As one particular example, a first action ML model can be trained and used to process RGB images that include a red channel, a green channel, and a blue channel. Further, a second action ML model can be trained and used to process depth images that include a depth channel and, optionally, lack any additional channels and/or lack any color channel(s). The first action ML model is not trained or used to process depth images and the second action ML model is not trained or used to process RGB images. The RGB images can be generated by a simulated or real sensor(s), such as those of a standalone RGB camera or sensor(s) of an RGB-D camera (e.g., one of a pair of RGB sensors). The depth images can be generated by simulated or real sensor(s), such as those of a standalone depth camera (e.g., an active depth camera that projects an infrared pattern and includes sensor(s) for detecting the projection) or those of an RGB-D camera (e.g., depth images generated based on comparing a pair RGB images from a pair of RGB sensors of the camera, and with knowledge of the relative poses between the pair of RGB sensors).

Continuing with the particular example, RGB images (real or simulated) and depth images (real or simulated) can be stored from a human demonstration (real or simulated) of the robotic task, along with a corresponding ground truth robotic action for each of the RGB images and depth images. The corresponding ground truth robotic action for an image reflects the robotic action that was dictated by the human, during the demonstration, at a time corresponding to the image. The RGB images and their ground truth robotic actions can be used in training the first action ML model. Likewise, the depth images and their ground truth robotic actions can be used in training the second action ML model. Accordingly, the first action ML model will be trained for use in generating predicted robotic actions based on RGB images and the second action ML model will be trained for use in generating predicted robotic actions based on depth images.

Although this particular example and various other examples provided herein describe RGB images as the first modality and depth images as the second modality, it is understood that models can be trained for and used with additional and/or alternative modalities. For example, a first action model can be trained for use in generating predicted robotic actions based on thermal images and a second action ML model can be trained for use in generating predicted robotic actions based on RGB images. As another example, a first action model can be trained for use in generating predicted robotic actions based on RGB-D images and the second action ML model can be trained for use in generating predicted robotic actions based on grayscale images. As yet another example, a first action model can be trained for use in generating predicted robotic actions based on RGB images, a second action ML model can be trained for use in generating predicted robotic actions based on depth images, and a third action model can be trained for use in generating predicted robotic actions based on RGB-D images.

Some implementations that relate to using trained robotic action ML model(s) in controlling the robot to perform robotic task(s), more particularly relate to utilization of such multiple action ML models each trained for use with a disparate sensor data modality. In those implementations, the robot includes sensor(s) that generate sensor data instances for a first modality of a first trained robotic action ML model and also includes sensor(s) that generate sensor data instances for a second modality of a second trained robotic action ML model. The sensor(s) that generate sensor data instances for the first modality can be mutually exclusive from those that generate sensor data instances for the second modality or can include sensor(s) in common (e.g., where RGB is one modality, depth is the other modality, and depth is generated based on output from RGB sensors).

Accordingly, in those implementations first modality sensor data instances are processed using the first robotic action ML model to generate first predicted action outputs and second modality sensor data instances are processed using the second robotic action ML model to generate second predicted action outputs. At each iteration of attempting performance of a robotic task for which the robotic action ML models are trained, a final predicted action output can be determined and implemented. The final predicted action output at each iteration can be based on at least one of: (a) a corresponding first predicted action output and (b) a corresponding second predicted action output. For example, at some iterations the final predicted action output can be determined based on (e.g., conform to) the corresponding first predicted action output and without any influence of the corresponding second predicted action output and, at other iterations, the final predicted action output can be determined based on (e.g., conform to) the corresponding second predicted action output and without any influence of the corresponding first predicted action output. Also, for example, at some iterations the final predicted action output can additionally or alternatively be determined based on a combination (e.g., a weighted combination such as a weighted average) of both the corresponding first predicted action output and the corresponding second predicted action output. Accordingly, as opposed to generating a final predicted action output based on a naïve fixed combination of the corresponding first predicted action output and the corresponding second predicted action output, various implementations disclosed herein dynamically determine, at each iteration, how the final predicted action output is to be generated.

In various implementations, determining how to generate a corresponding final predicted action output is based on analysis of: (a) a corresponding first embedding generated over the initial layers of the first action ML model in generating the corresponding first predicted action output; and (b) a corresponding second embedding generated over the initial layers of the second action ML model in generating the corresponding second predicted action output. For example, the corresponding first embedding and the corresponding second embedding can each be a respective stochastic embedding as described herein. The two stochastic embeddings can be analyzed, and a higher weight can be determined to be afforded to the predicted action output whose corresponding embedding indicates the lesser degree of uncertainty (e.g., has a lesser extent of variance(s)). For example, in determining which embedding indicates the lesser degree of uncertainty, a first distribution parameterized by the corresponding first embedding can be compared to a second distribution parameterized by the corresponding second embedding. For instance, a first VIB rate of the first embedding can be compared to a second VIB rate of the second embedding. The VIB rate of an embedding can be, for example, a Kullback-Leibler divergence (e.g., in nats) of the state-posterior from the state-prior. As one particular example, the first embedding can be generated based on processing an RGB image and the second embedding can be generated based on processing a depth image. The second embedding can indicate a lesser degree of uncertainty as a result of, for example, the depth image being similar to one or more of the depth images on which the second action ML model was trained. In contrast, the first embedding can indicate a relatively greater degree of uncertainty as a result of, for example, the RGB image not being similar to one or more of the RGB images on which the first action ML model was trained. This can be the case even when the first and second action models are trained based on the same demonstrations. For example, the scene captured by the RGB image and the depth image can be very similar, depth-wise, to a scene from one of the demonstrations while still varying significantly, color-wise, from that scene.

In some implementations or iterations, the predicted action output, whose corresponding embedding indicates the lesser degree of uncertainty, can be assigned a weight of “one” and the other predicted action output can be assigned a weight of “zero”. In those implementations or iterations, the final predicted action output can be generated based on (e.g., conform to) the predicted action output with the weight of “one” without consideration of the other predicted action output(s). In some implementations or iterations, the predicted action output, whose corresponding embedding indicates the lesser degree of uncertainty, can be assigned a first weight that is greater than a non-zero second weight assigned to the other predicted action output. For example, the first weight can be 0.65 and the second weight can be 0.35. The final predicted action output can then be generated as a function of the first predicted action output and the first weight and the second predicted action output and the second weight. For example, the final predicted action output can be a weighted average of the first and second predicted action outputs, where the first predicted action output is weighted using the first weight and the second predicted action output is weighted using the second weight. Optionally, the first weight can be generated as a function of a first degree of uncertainty indicated by the first stochastic embedding and/or as a function of a second degree of uncertainty indicated by the second stochastic embedding. For example, if the first degree of uncertainty is lesser than the second degree of uncertainty, but the degrees are within a first threshold, then the first weight can be 0.6 and the second weight 0.4. Continuing with the example, if the degrees are not within the first threshold, but within a second more permissive threshold, then the first weight can be 0.75 and the second weight can be 0.25. Additional and/or alternative rules-based and/or formula-based techniques for determining respective weights, in dependence on degree(s) of uncertainty, can be utilized.

Thus, at each iteration the corresponding embeddings, generated over multiple disparate models in generating corresponding predicted action outputs, can be analyzed to dynamically determine how the final predicted action output is to be generated. For example, the analysis can be used to select, at each iteration of an episode of attempting performance of a robotic task, a corresponding predicted action output, from a single of multiple action ML model, to which the final predicted action output should conform. For instance, a first subset of the iterations can use a final predicted action output that conforms to the predicted action output generated using a first modality action ML model while a second subset of the iterations can use a final predicted action output that conforms to the predicted action output generated using a second modality action ML model. Since the embeddings, analyzed in determining how to generate the final predicted action output, reflect uncertainty (e.g., directly as in the case of stochastic embeddings) of the corresponding action ML model, this can enable determinations of final action predictions that are more likely to result in successful performance of the robotic task. This can result in a greater rate of successful performance of the robotic task and/or enable more robust (e.g., across a larger range of environments) performance of the robotic task.

As a working example for providing additional description of some implementations described herein, assume that each action ML model is a policy model that generates, at each iteration, predicted action output(s) based on processing a corresponding instance of vision data, in a modality corresponding to the action ML model. The corresponding instance of vision data captures an environment of a robot during performance of a robotic task. Continuing with the working example, an instance of vision data can be processed using initial layers of the ML model to generate an embedding, and the embedding processed using additional layers of the ML model to generate the predicted action output(s). For example, the generated embedding can be a stochastic embedding, the stochastic embedding sampled, and resulting embedding(s) from the sampling processed using the additional layers. In some implementations, the action ML model can additionally or alternatively process, in addition to the sensor data instance, state data (e.g., environmental state data and/or robot state data) in generating the predicted action output(s). Continuing with the working example and assuming the resulting embedding(s) is a single embedding, a first predicted action output can be generated by processing the embedding using a first control head that includes a subset of the additional layers, and the first predicted action output can reflect action(s) for an arm of the robot. Continuing with the working example, a second predicted action output can be generated by processing the embedding using a second control head that includes another subset of the additional layers, and the second predicted action output can reflect action(s) for a base of the robot. Continuing with the working example, a third predicted action output can be generated by processing the embedding using a third control head that includes another subset of the additional layers, and the third predicted action output can reflect whether the episode of performing the robotic task should be terminated.

Continuing with the working example, assume a human guided demonstration of a robotic task was performed in simulation (e.g., the human utilized controller(s) in controlling a simulated robot to perform the robotic task). A simulated image, that is from the perspective of a simulated vision component of the simulated robot at a given time of the demonstration, can be obtained, along with ground truth action outputs for the given time. For example, the ground truth action outputs for the given time can be based on a next robotic action implemented as a result of the human guided demonstration.

The simulated image can be processed, using the initial layers of the action model, to generate a simulated embedding. Further, the simulated embedding can be processed, using the additional layers, to generate simulated first control head action output, simulated second control head action output, and simulated third control head action output. Supervised loss(es) can be generated based on comparing the simulated control head action outputs to the ground truth action outputs. For example, a first simulated supervised loss can be generated based on comparing the simulated first control head action output to a corresponding subset of the ground truth action outputs, a second simulated supervised loss can be generated based on comparing the simulated second control head action output to a corresponding subset of the ground truth action outputs, and a third simulated supervised loss can be generated based on comparing the simulated third control head action output to a corresponding subset of the ground truth action outputs. A measure, such as a VIB rate, can also be generated based on comparing the simulated embedding to the simulated image. The VIB objective can be used to generate a VIB loss (e.g., a gradient) that seeks to reward a low supervised loss (i.e., seeks to minimize the supervised loss) while penalizing a measure that indicates a high degree of similarity between the simulated embedding and the simulated image (i.e., seeks to maximize divergence between the simulated embedding and the simulated image. In some implementations, the VIB loss can be applied to (e.g., backpropagated across) the entirety of the action model to update the action ML model. In some other implementations, the supervised loss can be applied to the entirety of the action model and the VIB loss applied to the initial layers. In implementations where multiple supervised losses are generated (e.g., one or more supervised losses per control head), applying the supervised loss to the entirety of the action ML model can include applying first supervised loss(es) to a corresponding first control head, applying second supervised loss(es) to a corresponding second control head, etc.

The above description is provided as an overview of only some implementations disclosed herein. These and other implementations are described in more detail herein, including in the detailed description, the claims, the figures, and the appended paper.

Other implementations can include a non-transitory computer readable storage medium storing instructions executable by one or more processor(s) (e.g., a central processing unit(s) (CPU(s)), graphics processing unit(s) (GPU(s)), and/or tensor processing unit(s) (TPU(s))) to perform a method such as one or more of the methods described above and/or elsewhere herein. Yet other implementations can include a system of one or more computers and/or one or more robots that include one or more processors operable to execute stored instructions to perform a method such as one or more of the methods described above and/or elsewhere herein.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1 illustrates an example environment in which implementations related to training action machine learning models can be implemented.

FIG. 2A illustrates an example of a first action machine learning model and example data that can be utilized in training the first action machine learning model.

FIG. 2B illustrates an example of a second action machine learning model and example data that can be utilized in training the second action ML model.

FIG. 3A is a flowchart illustrating an example method of training a first action machine learning model.

FIG. 3B is a flowchart illustrating an example method of training a second action machine learning model.

FIG. 4 illustrates an example environment in which implementations related to using trained action machine learning models can be implemented.

FIG. 5 illustrates an example of utilizing a first action machine learning model and a second action machine learning model in dynamically determining final predicted action output to utilize in controlling a robot during an iteration of attempting performance of a robotic task.

FIG. 6 is a flowchart illustrating an example method of utilizing a first action machine learning model and a second action machine learning model in dynamically determining final predicted action output to utilize in controlling a robot during an iteration of attempting performance of a robotic task.

FIG. 7 schematically depicts an example architecture of a robot, in accordance with various implementations disclosed herein.

FIG. 8 schematically depicts an example architecture of a computer system, in accordance with various implementations disclosed herein.

### DETAILED DESCRIPTION

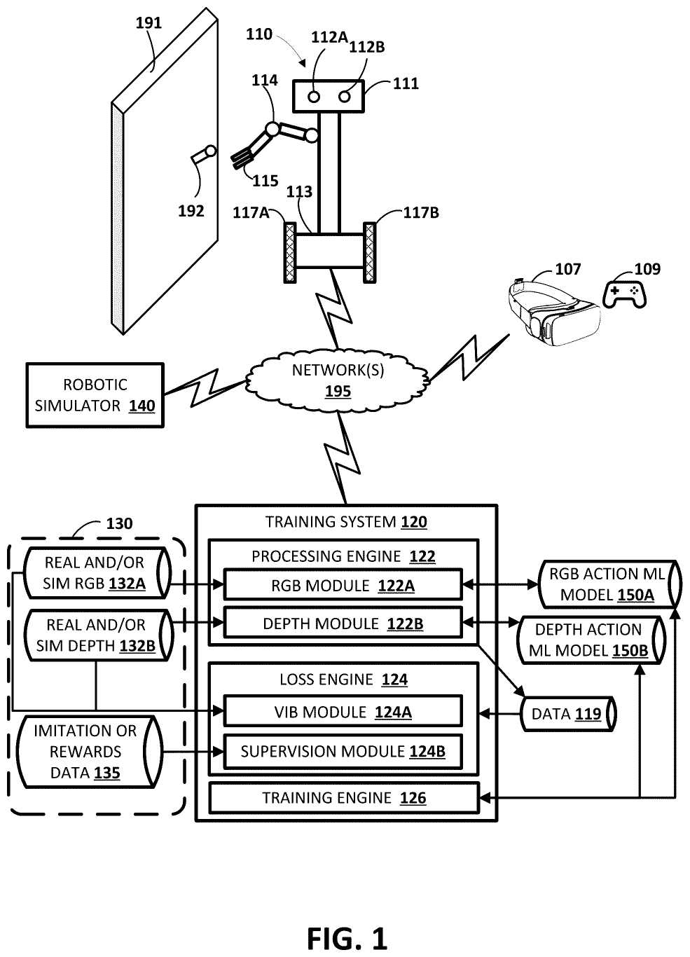

FIG. 1 illustrates an example environment in which implementations related to training action machine learning (ML) models can be implemented. The example environment includes a robot 110, a computing device 107, a robotic simulator 140, and a training system 120. One or more of these components of FIG. 1 can be communicatively coupled over one or more networks 195, such as local area networks (LANs), wide area networks (WANs), and/or any other communication network. The environment also includes two non-limiting examples of action ML models: RGB action ML model 150A and depth action ML model 150B.

In implementations that train action ML models 150A and 150B utilizing demonstration data and imitation learning, the computing device 107, which takes the form of a VR and/or AR headset, can be utilized to render various graphical user interfaces for facilitating provision of demonstration data by a human user. Further, the computing device 107 may utilize controller 109 (or other controller(s)) as an input device, or simply track eye and/or hand movements of a user of the computing device 107 via various sensors of the computing device 120 to control the robot 110 and/or to control a simulated robot of the robotic simulator 130. Additional and/or alternative computing device(s) can be utilized to provide demonstration data, such as desktop or laptop devices that can include a display and various input devices, such as a keyboard and mouse. Although particular components are depicted in FIG. 1 it should be understood that is for the sake of example and is not meant to be limiting.

The robot 110 illustrated in FIG. 1 is a particular real-world mobile robot. However, additional and/or alternative robots can be utilized with techniques disclosed herein, such as additional robots that vary in one or more respects from robot 110 illustrated in FIG. 1. For example, a stationary robot arm, a mobile telepresence robot, a mobile forklift robot, an unmanned aerial vehicle (“UAV”), and/or a humanoid robot can be utilized instead of or in addition to robot 110, in techniques described herein. Further, the robot 110 may include one or more engines implemented by processor(s) of the robot and/or by one or more processor(s) that are remote from, but in communication with, the robot 110.

The robot 110 includes one or more vision components, such as vision components 112A and 112B. Each of the vision components can generate, using respective vision sensor(s), vision sensor data that captures shape, color, depth, and/or other features of object(s) that are in the line of sight of the vision component. Some vision components can generate vision sensor data instances that are all of a single modality. For example, the vision component 112A could be a standalone RGB camera that generates only RGB images. Other vision components can generate first vision sensor data instances of a first modality and vision sensor data instances of a second modality. For example, the vision component 112A could instead be an RGB-D camera that generates RGB images and that also generates depth images. The vision sensor data instances generated by one or more of the vision components can include, for example, one or more color channels (e.g., a red channel, a green channel, and a blue channel) and/or one or more additional channels (e.g., a depth channel). For example, the vision component(s) 112 can include an RGB-D camera (e.g., a stereographic camera) that can generate RGB-D images. The robot 110 can also include position sensor(s), torque sensor(s), and/or other sensor(s) that can generate data and such data, or data derived therefrom, can form some or all of state data (if any).

The robot 110 also includes a base 113 with wheels 117A, 117B provided on opposed sides thereof for locomotion of the robot 110. The base 113 can include, for example, one or more motors for driving the wheels 117A, 117B of the robot 110 to achieve a desired direction, velocity, and/or acceleration of movement for the robot 110.

The robot 110 also includes one or more processors that, for example: provide control commands to actuators and/or other operational components thereof. The control commands provided to actuator(s) and/or other operational component(s) can, during demonstrations, be based on input(s) from a human and can form part of the action data (if any) that is included in ground truth demonstration data. Further, final predicted action output(s) that are generated based on trained action ML models 150A and 150B deployed on the robot 110 can be used in generating the control commands to provide to actuator(s) and/or other operational component(s).

The robot 110 also includes robot arm 114 with end effector 115 that takes the form of a gripper with two opposing “fingers” or “digits.” Additional and/or alternative end effectors can be utilized, or even no end effector. For example, alternative grasping end effectors can be utilized that utilize alternate finger/digit arrangements, that utilize suction cup(s) (e.g., in lieu of fingers/digits), that utilize magnet(s) (e.g., in lieu of fingers/digits), etc. Also, for example, a non-grasping end effector can be utilized such as an end effector that includes a drill, an impacting tool, etc.

In some implementations, a human can utilize computing device 107 (or input devices thereof) and/or other computing device to control the robot 110 to perform a human-guided demonstration of a robotic task. For example, the user can utilize the controller 109 associated with the computing device 107 and demonstration data can be generated based on instances of vision data captured by one or more of the vision components 112 during the demonstration, and based on ground truth action output values generated during the demonstration. In additional or alternative implementations, the user can perform the demonstration by physically manipulating the robot 110 or one or more components thereof (e.g., the base 113, the robot arm 114, the end effector 115, and/or other components). For example, the user can physically manipulate the robot arm 114, and the demonstration data can be generated based on the instances of the vision data captured by one or more of the vision components 112 and based on the physical manipulation of the robot 110. The user can repeat this process to generate demonstration data for performance of various robotic tasks.

One non-limiting example of a robotic task that can be demonstrated is a door opening task. For example, the user can control (e.g., via computing device 107) the base 113 and the arm 114 of the robot 110 to cause the robot 110 to navigate toward the door 191, to cause the end effector 115 to contact and rotate the handle 192 of the door 191, to move the base 113 and/or the arm 114 to push (or pull) the door 191 open, and to move the base 113 to cause the robot 110 to navigate through the door 191 while the door 191 remains open. Demonstration data from the demonstration can include sensor data generated by sensors of the robot, such as first sensor data instances generated by vision component 112A and second sensor data instances generated by vision component 112B during the demonstration. The demonstration data can further include ground truth action outputs that correspond to each of the sensor data instances. The ground truth action outputs can be based on control commands that are issued responsive to the human guidance. For example, images and action outputs can be sampled at 10 Hz or other frequency and stored as the demonstration data from a demonstration of a robotic task.

In some implementations, the human demonstrations can be performed in a real-world environment using the robot 110 (e.g., as described above). In additional or alternative implementations, the human demonstrations can be performed in a simulated environment using a simulated instance of the robot 110 via the robotic simulator 140. For example, in implementations where the human demonstrations are performed in the simulated environment using a simulated instance of the robot 110, a simulated configuration engine can access the object model(s) database to generate a simulated environment with a door and/or with other environmental objects. Further, the user can control the simulated instance of the robot 110 to perform a simulated robotic task by causing the simulated instance of the robot 110 to perform a sequence of simulated actions.

In some implementations, the robotic simulator 140 can be implemented by one or more computer systems, and can be utilized to simulate various environments that include corresponding environmental objects, to simulate an instance the robot 110 operating in the simulated environment depicted in FIG. 1 and/or other environments, to simulate sensor data instances of various modalities, to simulate responses of the robot in response to virtual implementation of various simulated robotic actions in furtherance of various robotic tasks, and to simulate interactions between the robot and the environmental objects in response to the simulated robotic actions. Various simulators can be utilized, such as physics engines that simulate collision detection, soft and rigid body dynamics, etc. Accordingly, the human demonstrations and/or performance of various robotic tasks described herein can include those that are performed by the robot 110, that are performed by another real-world robot, and/or that are performed by a simulated instance of the robot 110 and/or other robots via the robotic simulator 140.

All or aspects of training system 120 can be implemented by the robot 110 in some implementations. In some implementations, all or aspects of training system 120 can be implemented by one or more remote computing systems and/or devices that are remote from the robot 110. Various modules or engines may be implemented as part of training system 120 as software, hardware, or any combination of the two. For example, as shown in FIG. 1, training system 120 can include a processing engine 122, a loss engine 124, and a training engine 126.

The processing engine 122 includes an RGB module 122A and a depth module 122B. The RGB module 122A processes real and/or simulated RGB images 132A, from training data, individually and using the RGB action ML model 150A, to generate a corresponding instance of data, and stores that data in database 119. For example, and as described herein, in processing a given RGB image using the RGB action ML model 150A, an embedding can be generated based on processing the RGB image using initial layers of the RGB action ML model 150A, and an action output can be generated based on processing the embedding using additional layers of the RGB action ML model 150A. The instance of data, for the given RGB image, can include the generated embedding and the generated action output.

The depth module 122B processes real and/or simulated depth images 132B, from training data, individually and using the depth action ML model 150B, to generate a corresponding instance of data, and stores that data in database 119. For example, and as described herein, in processing a given depth image using the depth action ML model 150B, an embedding can be generated based on processing the depth image using initial layers of the depth action ML model 150B, and an action output can be generated based on processing the embedding using additional layers of the depth action ML model 150B. The instance of data, for the given depth image, can include the generated embedding and the generated action output.

The loss engine 124 utilizes the instances of data, in database 119, in generating losses for training the action ML models 150A and 150B. More particularly, the loss engine 124 utilizes the instances of data that are generated by RGB module 122A in generating losses for training the RGB action ML model 150A, and utilizes the instances of data that are generated by depth module 122B in generating losses for training the depth action ML model 150B. The training engine 126 utilizes the generated losses in updating the action ML models 150A and 150B (e.g., by backpropagating the respective losses over the layers of the respective action ML models).

The loss engine 124 can include a VIB module 124A and a supervision module 124B. The supervision module 124B generates supervised losses. In generating supervised loss(es) for a data instance, the supervision module 124B can compare action output(s) from a data instance to supervised data, such as supervised data from imitation or rewards data 135. For example, the imitation or rewards data 135 can include ground truth imitation data, for the data instance, that reflects actual action output based on a corresponding human-guided demonstration episode. As another example, the imitation or rewards data 135 can include a sparse or intermediate reward, for the data instance, that is based on a reward function and data from a corresponding reinforcement learning episode. In some implementations, the supervision module 124B generates a single supervised loss for a data instance. In some other implementations, the supervision module 124B generates multiple supervised losses, with each of the supervised losses being for a corresponding control head. For example, assume a first control head predicts value(s) for action(s) of a base of the robot and a second control head predicts value(s) for action(s) of an end effector. In such an example, the supervision module 124B can generate a first supervised loss based on comparing the predicted value(s), from the first control head, to ground truth value(s) for action(s) of the base from imitation or rewards data 135. Further, the supervision module 124B can generate a second supervised loss based on comparing the predicted value(s), from the second control head, to ground truth value(s) for action(s) of the end effector from the imitation or rewards data 135.

The VIB module generates VIB losses. In some implementations, the VIB loss for a data instance is a function of the supervised loss(es) for that data instance (generated by supervision module 124B), and a function of comparison of the embedding of that data instance to the corresponding sensor data instance utilized in generating the embedding (e.g., the RGB image or the depth image).

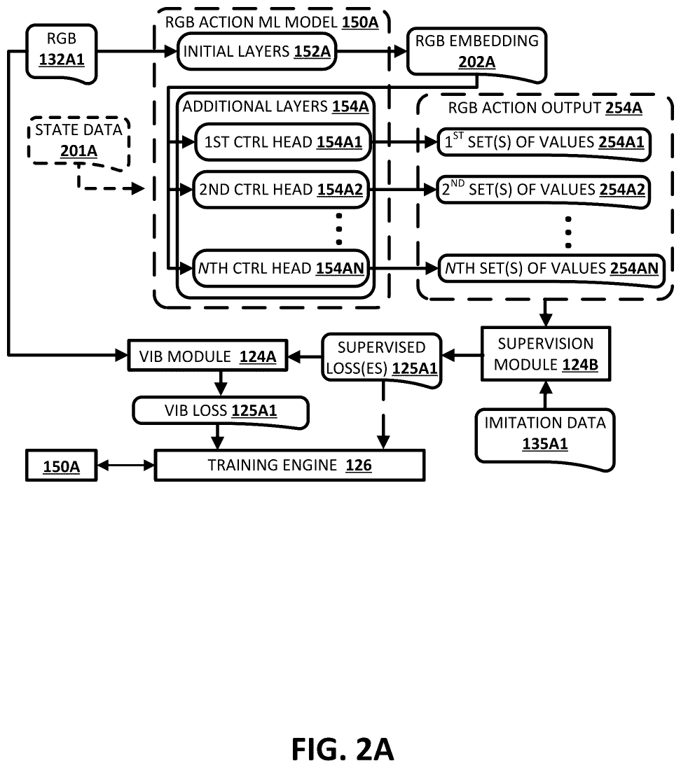

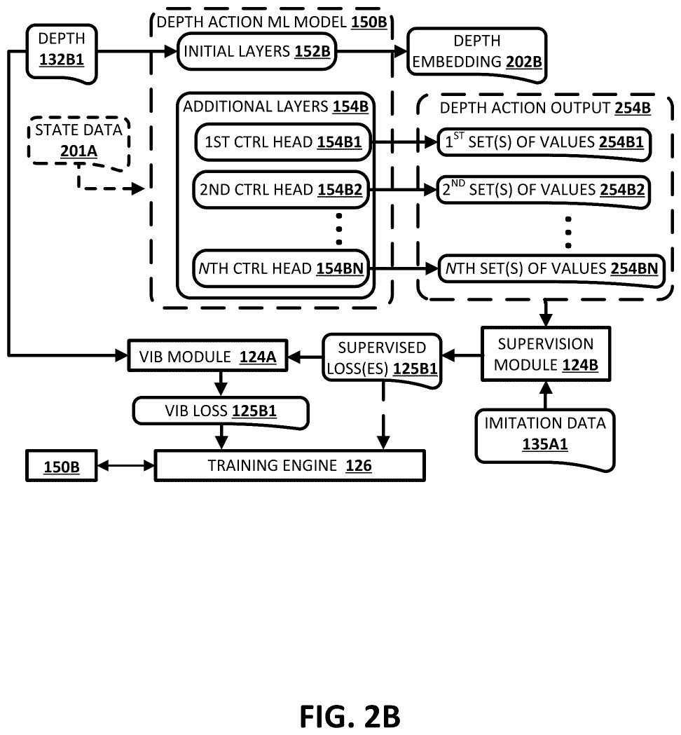

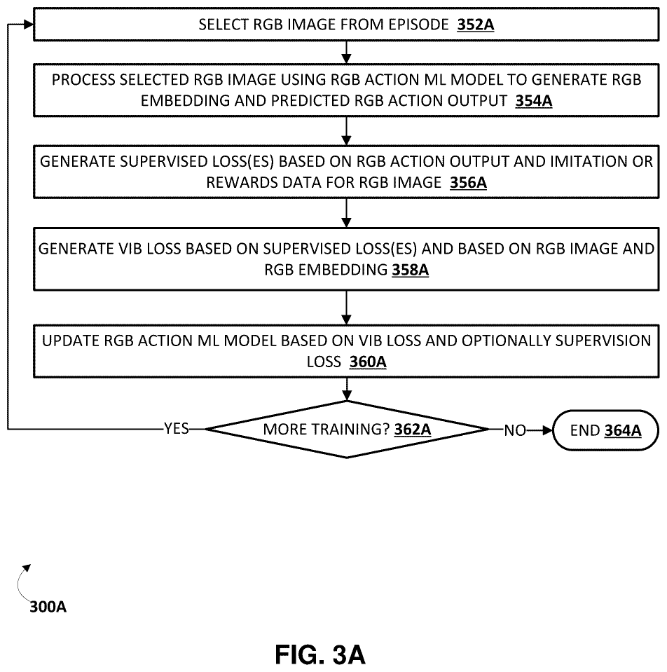

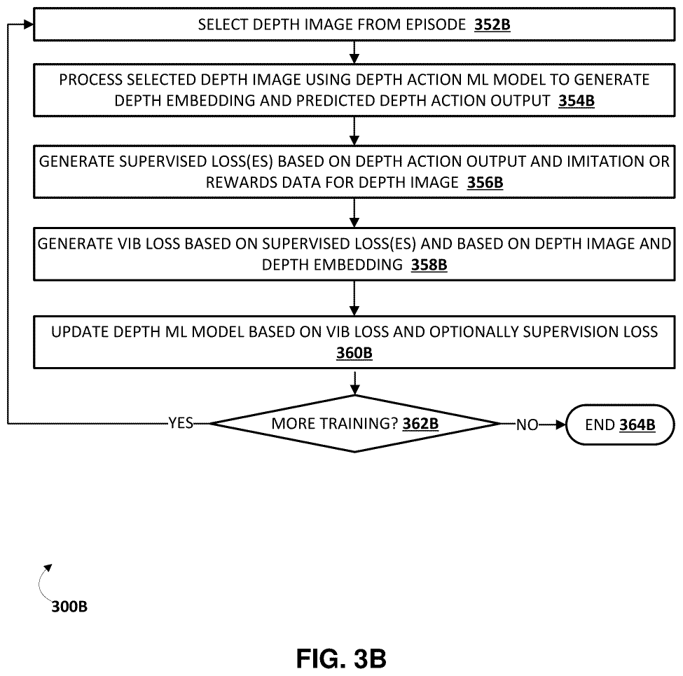

Turning now to FIGS. 2A, 2B, and 3, additional description is provided of various components of FIG. 1, as well as methods that can be implemented by various components of FIG. 1.

FIG. 2A illustrates an example of the RGB action ML model 150A of FIG. 1, and an example of how supervised loss(es) and/or a VIB loss can be generated in training the RGB action ML model 150A. The RGB image 132A1 can be from a real or simulated human demonstration and is paired with ground truth imitation data 135A1 that reflects robotic action output dictated by the human during the demonstration at or near the time of the RGB image 132A1.

The RGB image 132A1 is processed, using initial layers 152A of the RGB action ML model 150A, to generate an RGB embedding 202A, which can optionally be a stochastic embedding as described herein. Further, the generated RGB embedding 202A is processed, using additional layers 154A of the RGB action ML model 150A, to generate predicted RGB action output 254A. For example, when the RGB embedding 202A is a stochastic embedding, a sampled embedding, sampled from the distribution reflected by the stochastic embedding, can be processed using the additional layers 154A to generate the RGB action output 254A. In FIG. 2A, the additional layers 154A include control heads 154A1-N and the RGB action output 254A includes sets of values 254A1-N, each generated based on processing using a corresponding one of the control heads 154A1-N. For example, the 1st set of values 254A1 can define, directly or indirectly, parameters for movement of a base of a robot (e.g., base 113 of robot 110), such as direction, velocity, acceleration, and/or other parameters(s) of movement. Also, for example, the 2nd set of values 254A2 can define, directly or indirectly, parameters for movement of an end effector of the robot (e.g., end effector 115 of robot 110), such as translational direction, rotational direction, velocity, and/or acceleration of movement, whether to open or close a gripper, force(s) of moving the gripper translationally, and/or other parameter(s) of movement. Also, for example, the Nth set of values 254AN can define, directly or indirectly, whether a current episode of performing a robotic task is to be terminated (e.g., the episode of performing the robotic task is completed). In implementations where additional layers 154A include multiple control heads, more or fewer control heads can be provided. For example, additional action outputs could be generated, as indicated by the vertical ellipses in FIG. 2A. For instance, the 2nd set of values 254A2 can define translational direction of movement for the end effector, an additional unillustrated control head can generate values that define rotational direction of movement for the end effector, and a further additional unillustrated control head can generate values that define whether the end effector should be in an opened position or a closed position.

In generating the 1st set of values 254A1, the RGB embedding 202A can be processed using a first control head 154A1 that is a unique subset of the additional layers 154A. In generating the 2nd set of values 254A2, the RGB embedding 202A can be processed using a second control head 154A2 that is another unique subset of the additional layers 154A. In generating the Nth set of values 254AN, the RGB embedding 202A can be processed using an Nth control head 154AN that is yet another unique subset of the additional layers 154A. Put another way, the control heads 154A1-N can be parallel to one another in the network architecture, and each used in processing the RGB embedding 202A and generating a corresponding action output.

In some implementations, in addition to processing the RGB embedding 202A using the additional layers, other data can be processed along with the RGB embedding 202A (e.g., concatenated with the RGB embedding 202A). For example, optional non-image state data 201A can be processed along with the image embedding. The non-image state data 201A can include, for example, robot state data or an embedding of the robot state data. The robot state data can reflect, for example, current pose(s) of component(s) of the robot, such as current joint-space pose(s) of actuators of the robot and/or current Cartesian-space pose(s) of a base and/or of an arm of the robot.

In FIG. 2A, the supervision module 124B generates supervised loss(es) 125A1 based on comparing the predicted RGB action output 254A to the ground truth imitation data 135A1 that reflects robotic action output dictated by the human during the demonstration. The VIB module 124A generates a VIB loss 125A1 that can be based on the supervised loss(es) 125A1, and also based on a VIB rate or other measure that can optionally be generated based on comparing the RGB image 132A1 to the RGB embedding 202A. The training engine 126 can use the VIB loss 125A1 in updating at least the initial layers 152A of the RGB action model 150A. In some implementations, the training engine 126 can use the VIB loss 125A1 in updating the entirety of the RGB action model 150A (e.g., backpropagate the VIB loss 125A1 across the entire RGB action model 150A). Optionally, the training engine 126 can additionally utilize the supervised loss(es) 125A1 in updating the RGB action model 150A (e.g., backpropagate the supervised loss across the entire RGB action model 150A). Additional instances of RGB images and corresponding ground truth imitation data can be utilized to generate further losses for further training the RGB action ML model 150A.

The preceding description of FIG. 2A describes that a sampled embedding, sampled from the distribution reflected by the stochastic RGB embedding 202A, can be processed using the additional layers 154A to generate the RGB action output 254A. However, in some implementations multiple sampled embeddings can be sampled, and each individually processed using the additional layers 154A to generate a corresponding one of multiple RGB action outputs. In those implementations, supervised loss(es) can be generated for each of the RGB action output(s) (e.g., a first set of supervised loss(es) based on a first of the RGB action outputs, a second set of supervised loss(es) based on a second of the RGB action outputs, etc.). Further, in those implementations, an overall supervised loss, such as an average of the generated supervised losses, can be generated and used in the VIB objective. Further, in those implementations, multiple VIB rates or other measures can be generated, with each being generated based on a corresponding one of the multiple embeddings (e.g., based on comparing the RGB image 132A1 to the corresponding one of the embeddings).

FIG. 2B illustrates an example of the depth action ML model 150b of FIG. 1, and an example of how supervised loss(es) and/or a VIB loss can be generated in training the depth action ML model 150B. The depth image 132B1 can be from the same demonstration as the RGB image 132A1 of FIG. 2A. Further, the depth image 132B1 is one generated at or near the same time as the RGB image and, as a result, is paired with the same ground truth imitation data 135A1.

The depth image 132B1 is processed, using initial layers 152B of the depth action ML model 150B, to generate a depth embedding 202B, which can optionally be a stochastic embedding as described herein. Further, the generated depth embedding 202B is processed, using additional layers 154B of the depth action ML model 150B, to generate predicted depth action output 254B. For example, when the depth embedding is a stochastic embedding, a sampled embedding, sampled from the distribution reflected by the stochastic embedding, can be processed using the additional layers 154B to generate the depth action output 254B. In FIG. 2B, the additional layers 154B include control heads 154B1-N and the depth action output 254B includes sets of values 254B1-N, each generated based on processing using a corresponding one of the control heads 154B1-N. The additional layers 154B include the same amount of control heads as the additional layers 154A of RGB action ML model 150A. Further, they can have the same output dimensions and be utilized to predict values for the same corresponding parameters. For example, the 1st set of values 254B1 can define, directly or indirectly, parameters for movement of a base of a robot. Also, for example, the 2nd set of values 254B2 can define, directly or indirectly, parameters for movement of an end effector of the robot. Also, for example, the Nth set of values 254BN can define, directly or indirectly, whether a current episode of performing a robotic task is to be terminated (e.g., the episode of performing the robotic task is completed). In implementations where additional layers 154B include multiple control heads, more or fewer control heads can be provided.

In generating the 1st set of values 254B1, the depth embedding 202B can be processed using a first control head 154B1 that is a unique subset of the additional layers 154B. In generating the 2nd set of values 254B2, the depth embedding 202B can be processed using a second control head 154B2 that is another unique subset of the additional layers 154B. In generating the Nth set of values 254BN, the depth embedding 202B can be processed using an Nth control head 154BN that is yet another unique subset of the additional layers 154B. Put another way, the control heads 154B1-N can be parallel to one another in the network architecture, and each used processing the depth embedding 202B and generating a corresponding action output.

In some implementations, in addition to processing the depth embedding 202B using the additional layers, other data can be processed along with the depth embedding 202B. For example, optional non-image state data 201A can be processed along with the depth embedding 202B.

In FIG. 2B, the supervision module 124B generates a supervised loss(es) 125B1 based on comparing the predicted depth action output 254B to the ground truth imitation data 135A1 that reflects robotic action output dictated by the human during the demonstration. The VIB module 124A generates a VIB loss 125B1 that can be based on the supervised loss(es) 125B1, and also based on comparing the depth image 132B1 to the depth embedding 202B. It is noted that, even though the same ground truth imitation data 135A1 is utilized in FIG. 2A and FIG. 2B, the losses between the two figures can differ as a result of, for example, different input data (i.e., RGB image in FIG. 2A and depth image in FIG. 2B) and/or different learned weights of the initial and additional layers through prior iterations of training. The training engine 126 can use the VIB loss 125B1 in updating at least the initial layers 152B of the depth action model 150B. Optionally, the training engine 126 can additionally utilize the supervised loss(es) 125B1 in updating the depth action model 150B (e.g., backpropagate the supervised loss(es) across the entire RGB action model 150A). Additional instances of depth images and corresponding ground truth imitation data can be utilized to generate further losses for further training the depth action ML model 150B.

The preceding description of FIG. 2B describes that a sampled embedding, sampled from the distribution reflected by the stochastic depth embedding 202B, can be processed using the additional layers 154B to generate the depth action output 254B. However, in some implementations multiple sampled embeddings can be sampled, and each individually processed using the additional layers 154B to generate a corresponding one of multiple depth action outputs. In those implementations, supervised loss(es) can be generated for each of the depth action output(s) (e.g., a first set of supervised loss(es) based on a first of the depth action outputs, a second set of supervised loss(es) based on a second of the depth action outputs, etc.). Further, in those implementations, an overall supervised loss, such as an average of the generated supervised losses, can be generated and used in the VIB objective. Further, in those implementations, multiple VIB rates or other measures can be generated, with each being generated based on a corresponding one of the multiple embeddings (e.g., based on comparing the depth image 132B1 to the corresponding one of the embeddings).

FIG. 3A is a flowchart illustrating an example method 300A of training a first action machine learning model. FIG. 3B is a flowchart illustrating an example method 300B of training a second action machine learning model. For convenience, the operations of the methods 300A and 300B are described with reference to a system that performs the operations. This system may include one or more processors, such as processor(s) of training system 120. Moreover, while operations of methods 300A and 300B are shown in a particular order, this is not meant to be limiting. One or more operations may be reordered, omitted or added.

Turning initially to FIG. 3A, at block 352A, the system selects an RGB image from an episode, such as a demonstration episode.

At block 354A, the system processes the selected RGB image, using an RGB action ML model, to generate a predicted RGB embedding and predicted RGB action output. For example, the system can process the RGB image, using initial layers of the RGB action ML model, to generate the RGB embedding, then process the RGB embedding, using additional layers of the RGB action ML model, to generate the RGB action output.

At block 356A, the system generates supervised loss(es) based on the RGB action output and imitation or rewards data for the currently selected RGB image.

At block 358A, the system generates a VIB loss based on the supervised loss(es) and based on the currently selected RGB image and the RGB embedding. For example, further based on comparing the RGB image and the RGB embedding.

At block 360A, the system updates the RGB action ML model based on the VIB loss and, optionally, based on the supervised loss(es).

At block 362A, the system determines whether to perform more training. If so, the system proceeds back to block 352A and selects another RGB image from the same or another episode. If not, the system proceeds to block 364A and training of the RGB action ML model ends. In some implementations, in determining whether to perform more training, the system determines whether one or more training criteria are satisfied. Such criteria can include, for example, training for a threshold quantity of epochs, training based on a threshold quantity of images, training for a threshold duration of time, and/or validation of the currently trained action ML model.

Turning to FIG. 3B, at block 352B, the system selects a depth image from an episode, such as a demonstration episode.

At block 354B, the system processes the selected depth image, using a depth action ML model, to generate a predicted depth embedding and predicted depth action output. For example, the system can process the depth image, using initial layers of the depth action ML model, to generate the depth embedding, then process the depth embedding, using additional layers of the depth action ML model, to generate the depth action output.

At block 356B, the system generates supervised loss(es) based on the depth action output and imitation or rewards data for the currently selected depth image.

At block 358B, the system generates a VIB loss based on the supervised loss(es) and based on the currently selected depth image and the depth embedding. For example, further based on comparing the depth image and the depth embedding.

At block 360B, the system updates the depth action ML model based on the VIB loss and, optionally, based on the supervised loss(es).

At block 362B, the system determines whether to perform more training. If so, the system proceeds back to block 352B and selects another depth image from the same or another episode. If not, the system proceeds to block 364B and training of the RGB action ML model ends.

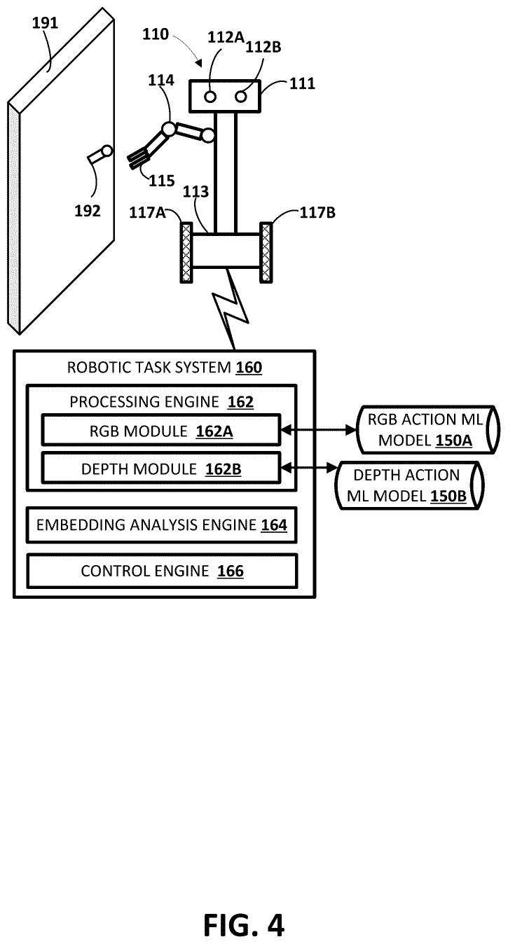

Turning now to FIGS. 4, 5, and 6, additional description is provided of using trained action machine learning models in control of a robot. Such trained action machine learning models can optionally be trained utilizing techniques described herein (e.g., with respect to FIGS. 1-3B).

In FIG. 4, the robot 110 of FIG. 1 is again illustrated, as is the door of FIG. 1. FIG. 4 further illustrates a robotic task system 160, which can be implemented by processor(s) of the robot 110 in various implementations. The robotic task system 160 can include a processing engine 162, and embedding analysis engine 164, and a control engine 166.

The processing engine 162 includes an RGB module 162A and a depth module 162B. The RGB module 162A processes real RGB images, captured by one of the vision components 112A or 112B of robot 110, individually and using the trained RGB action ML model 150A. In processing a real RGB image, the RGB module 162A generates a corresponding RGB embedding over initial layers of the model 150A and processes the corresponding RGB embedding over additional layers of the model 150A to generate a corresponding predicted RGB action output. At each iteration of attempting performance of a task, the RGB module 162A can process a current RGB image and generate a corresponding RGB embedding and corresponding predicted RGB action output.

The depth module 162B processes depth images, captured by one of the vision components 112A or 112B of robot 110, individually and using the trained depth action ML model 150B. In processing a real depth image, the depth module 162B generates a corresponding depth embedding over initial layers of the model 150B and processes the corresponding depth embedding over additional layers of the model 150B to generate a corresponding predicted depth action output. At each iteration of attempting performance of a task, the depth module 162B can process a current depth image and generate a corresponding depth embedding and corresponding predicted depth action output.

At each iteration, the control engine 166 utilizes a corresponding first weight, for the predicted RGB action output of that iteration, and a corresponding second weight, for the predicted depth action output of that iteration, in determining final predicted action output to utilize in that iteration in controlling component(s) of the robot. For example, if the first weight is zero and the second weight is one, the control engine 166 can determine final predicted action output that conforms to the predicted depth action output of that iteration.

The weights utilized by the control engine 166 at each iteration can be determined by embedding analysis engine 164. At each iteration, the embedding analysis engine 164 can analyze the RGB embedding of that iteration and the depth embedding of that iteration, and determine the first and second weights based on that analysis. For example, the embedding analysis engine 164 can determine to assign a higher weight to the predicted action output whose corresponding embedding indicates the lesser degree of uncertainty (e.g., has a lesser extent of variance(s)). For instance, in determining which embedding indicates the lesser degree of uncertainty, the embedding analysis engine 164 can compare a first distribution parameterized by the RGB embedding of an iteration to a second distribution parameterized by the depth embedding of the iteration.

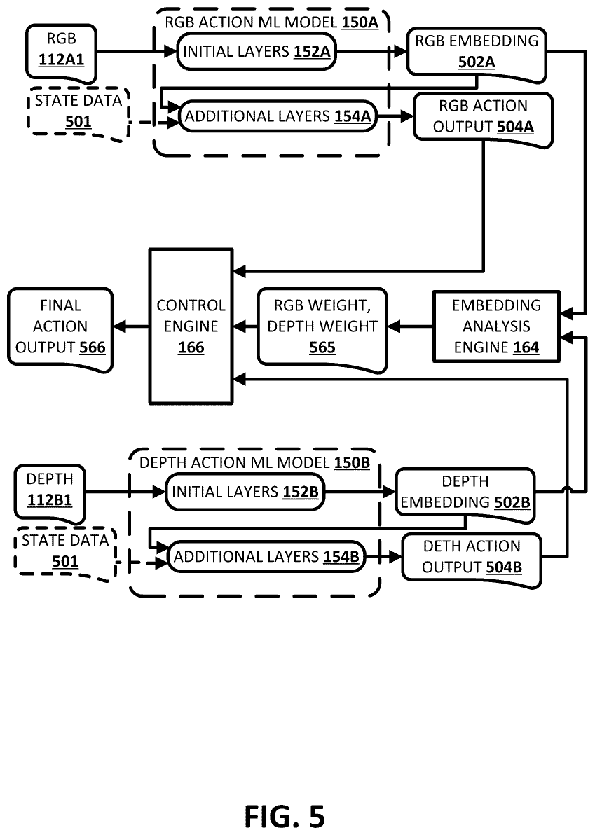

Turning to FIG. 5, an example is illustrated of processing that can be performed by components of robotic task system 160 in a given iteration. The RGB module 162A (not illustrated in FIG. 5) can process a current RGB image 112A1 utilizing initial layers 152A, of trained RGB action ML model 150A, to generate an RGB embedding 502A. Further, the RGB module 162A can process the RGB embedding 502A, and optionally current state data 501, using additional layers 154A of trained RGB action ML model 150A, to generate predicted RGB action output 504A.

In parallel with the processing by the RGB module 162A, the depth module 162B (not illustrated in FIG. 5) can process a current depth image 112B1 utilizing initial layers 152B, of trained depth action ML model 150B, to generate a depth embedding 502B. Further, the depth module 162B can process the depth embedding 502B, and optionally current state data 501, using additional layers 154B of trained depth action ML model 150B, to generate predicted depth action output 504BA. It is noted that the current RGB image 112A1 and the current depth image 112B1 can be generated at or near (e.g., within 0.2 seconds of, within 0.1 seconds of, or within another threshold of one another) the same time.

The RGB embedding 502A and the depth embedding 502B are provided to the embedding analysis engine 164. The embedding analysis engine 164 analyzes (e.g., compares) the RGB embedding 502A and the depth embedding 502B and, based on that comparison, determines an RGB weight (for the RGB action output 504A) and a depth weight (for the depth action output 504B) 565. The RGB weight and the depth weight 565 are provided to the control engine 166, along with the RGB action output 504A and the depth action output 504B.

The control engine 166 determines final action output 566 based on the RGB weight and the depth weight 565 and at least one of the RGB action output 504A and the depth action output 504B. For example, if the RGB weights is zero and the depth output is one, then the control engine 166 can determine final action output 566 that conforms to the depth action output 504B. As another example, if the RGB weights is 0.7 and the depth output is 0.3, then the control engine 166 can determine final action output 566 that is a weighted combination of the depth action output 504B and the RGB action output 504A, weighting the depth action output 504B by 0.3 and the RGB action output 504A by 0.7. The control engine 166 causes the final action output 566 to be implemented by, for example, providing corresponding control commands to actuator(s) of the robot 110.

FIG. 5 illustrates one iteration of generating final action output during attempting performance of a task. However, it is understood that during attempting performance of a task a sequence of final action outputs will be generated, each being generated based on processing of new current RGB and depth images using respective of action ML models 150A and 150B.

The preceding description of FIG. 5 describes that a sampled embedding, sampled from the distribution reflected by the stochastic RGB embedding 502A, can be processed using the additional layers 154A to generate the RGB action output 504A. However, in some implementations multiple sampled embeddings can be sampled, and each individually processed using the additional layers 154A to generate a corresponding one of multiple RGB action outputs. In those implementations, the RGB action output 504A can be a function of the multiple RGB action outputs. For example, the RGB action output 504A can be an average or other combination of the multiple RGB action outputs.

Further, the preceding description of FIG. 5 describes that a sampled embedding, sampled from the distribution reflected by the stochastic depth embedding 502B, can be processed using the additional layers 154B to generate the depth action output 504B. However, in some implementations multiple sampled embeddings can be sampled, and each individually processed using the additional layers 154B to generate a corresponding one of multiple depth action outputs. In those implementations, the depth action output 504B can be a function of the multiple depth action outputs. For example, the depth action output 504B can be an average or other combination of the multiple depth action outputs.

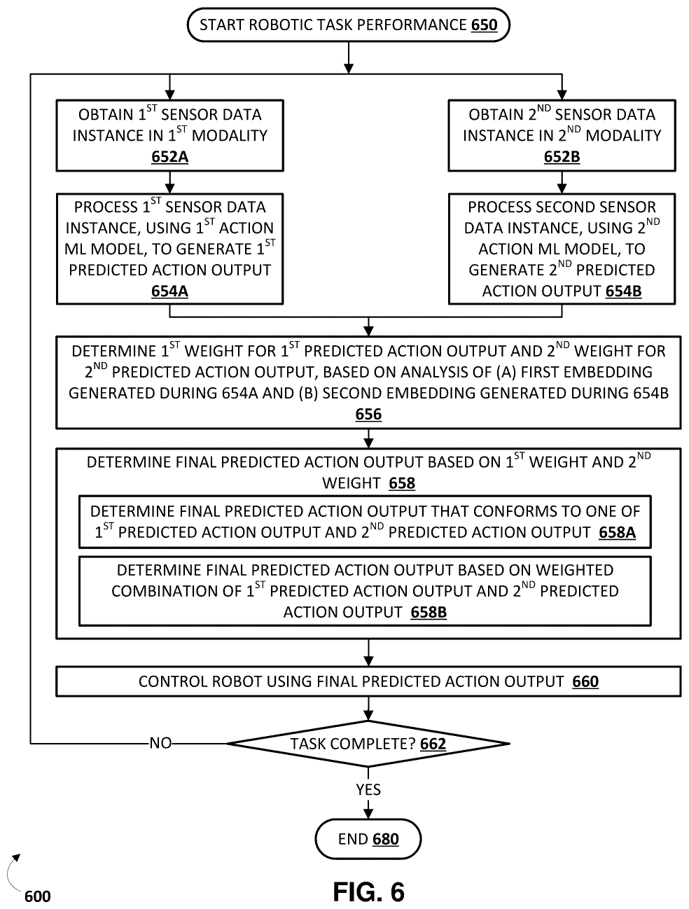

Turning now to FIG. 6, a flowchart is illustrated of an example method 600 of utilizing a first action machine learning model and a second action machine learning model in dynamically determining final predicted action output to utilize in controlling a robot during an iteration of attempting performance of a robotic task. For convenience, the operations of the method 600 are described with reference to a system that performs the operations. This system may include one or more processors, such as processor(s) of robot 110 or other robot. Moreover, while operations of method 600 are shown in a particular order, this is not meant to be limiting. One or more operations may be reordered, omitted or added.

At block 650, the system starts robotic task performance. For example, the system can start robotic task performance responsive to a request from a user or responsive to a request from a higher-level task planning system of the robot.

The system then performs blocks 652A and 654A in parallel with performance of blocks 652B and 654B.

At block 652A, the system obtains a first sensor data instance in a first modality. For example, the first sensor data instance can be an RGB image that lacks any depth channel and lacks any thermal channel.

At block 654A, the system processes the first sensor data instance, using a first action ML model, to generate first predicted action output.

At block 652B, the system obtains a second sensor data instance in a second modality. For example, the second sensor data instance can be a thermal image that includes thermal channel(s), but lacks any depth channel and lacks any color channel.

At block 654B, the system processes the second sensor data instance, using a second action ML model, to generate second predicted action output.

At block 656, the system determines a first weight for the first predicted action output and a second weight for the second predicted action output. The system can determine the first and second weights based on analysis of (a) a first embedding generated in the processing of block 654A and (b) a second embedding generated in the processing of block 654B.

At block 658, the system determines a final predicted action output based on (a) the first weight and the second weight determined at block 656 and (b) at least one of the first predicted action output (determined at block 654A) and the second predicted action output (determined at block 654B). In some implementations or iterations, block 658 includes sub-block 658A. In some other implementations or iterations, block 658 includes sub-block 658B.

At sub-block 658A, the system determines a final predicted action output that conforms to one of the first predicted action output and the second predicted action output. For example, the system can determine the final predicted action output to conform to the predicted action output with the highest weight. In some implementations, sub-block 658A is performed, in lieu of sub-block 658B, based on one of the weights being at least a threshold degree higher than the other of the weights.

At sub-block 658B, the system determines a final predicted action output based on a weighted combination of the first predicted action output and the 2 nd predicted action output. For example, the system can determine the final predicted action output based on an average or other combination of the first and second predicted action outputs, weighting each based on their respective weights. In some implementations, sub-block 658B is performed, in lieu of sub-block 658A, based on one of the weights being within a threshold degree of one another.

At block 660, the system controls the robot using the final predicted action output. For example, the system can send control commands, to actuator(s) of the robot, that conform the final predicted action output.

At block 662, the system determines whether the task is complete. If not, the system proceeds back to blocks 652A and 652B, obtaining new current sensor data instances in each. If so, the system proceeds to block 680 and the current attempt at performance of the task ends. In some implementations, in determining whether the task is complete, the system determines whether the most recently determined final action output (i.e., in a most recent iteration of block 658) is an end/complete action. If so, the system can omit performance of block 660 for the end/complete action and, rather, proceed to block 662 and determine the task is complete. In some implementations, in determining whether the task is complete, the system can assess various sensor data to determine whether the task is complete and/or utilize human feedback in determining whether the task is complete.

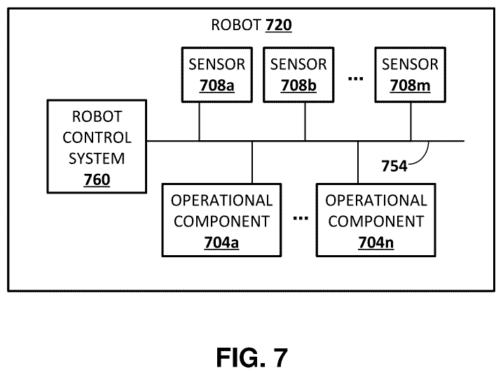

FIG. 7 schematically depicts an example architecture of a robot 720. The robot 720 includes a robot control system 760, one or more operational components 704a-n, and one or more sensors 708a-m. The sensors 708a-m can include, for example, vision components, pressure sensors, positional sensors, pressure wave sensors (e.g., microphones), proximity sensors, accelerometers, gyroscopes, thermometers, barometers, and so forth. While sensors 708a-m are depicted as being integral with robot 720, this is not meant to be limiting. In some implementations, sensors 708a-m may be located external to robot 720, e.g., as standalone units.

Operational components 704a-n can include, for example, one or more end effectors (e.g., grasping end effectors) and/or one or more servo motors or other actuators to effectuate movement of one or more components of the robot. For example, the robot 720 can have multiple degrees of freedom and each of the actuators can control actuation of the robot 720 within one or more of the degrees of freedom responsive to control commands provided by the robot control system 760 (e.g., torque and/or other commands generated based on action outputs from a trained action ML model). As used herein, the term actuator encompasses a mechanical or electrical device that creates motion (e.g., a motor), in addition to any driver(s) that may be associated with the actuator and that translate received control commands into one or more signals for driving the actuator. Accordingly, providing a control command to an actuator can comprise providing the control command to a driver that translates the control command into appropriate signals for driving an electrical or mechanical device to create desired motion.

The robot control system 760 can be implemented in one or more processors, such as a CPU, GPU, and/or other controller(s) of the robot 720. In some implementations, the robot 720 may comprise a “brain box” that may include all or aspects of the control system 760. For example, the brain box may provide real time bursts of data to the operational components 704a-n, with each of the real time bursts comprising a set of one or more control commands that dictate, inter alio, the parameters of motion (if any) for each of one or more of the operational components 704a-n. In various implementations, the control commands can be at least selectively generated by the control system 760 based at least in part on final predicted action outputs and/or other determination(s) made using action machine learning model(s) that are stored locally on the robot 720, such as those described herein.

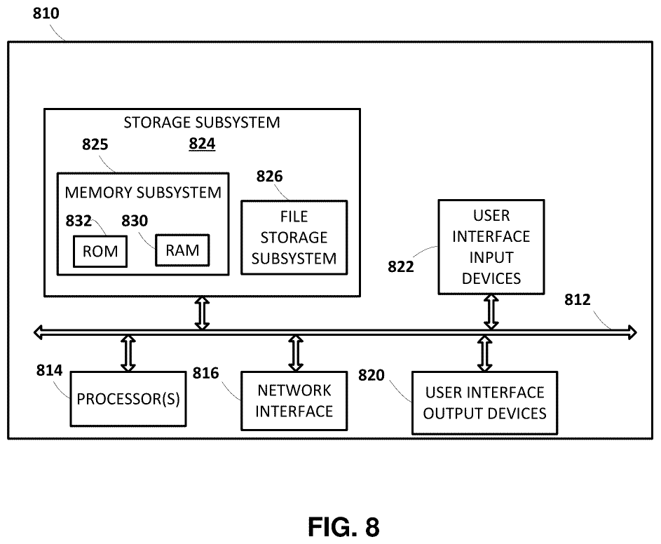

Although control system 760 is illustrated in FIG. 7 as an integral part of the robot 720, in some implementations, all or aspects of the control system 760 can be implemented in a component that is separate from, but in communication with, robot 720. For example, all or aspects of control system 760 may be implemented on one or more computing devices that are in wired and/or wireless communication with the robot 720, such as computing device 810 of FIG. 8.

FIG. 8 is a block diagram of an example computing device 810 that can optionally be utilized to perform one or more aspects of techniques described herein. Computing device 810 typically includes at least one processor 814 which communicates with a number of peripheral devices via bus subsystem 812. These peripheral devices may include a storage subsystem 824, including, for example, a memory subsystem 825 and a file storage subsystem 826, user interface output devices 820, user interface input devices 822, and a network interface subsystem 816. The input and output devices allow user interaction with computing device 810. Network interface subsystem 816 provides an interface to outside networks and is coupled to corresponding interface devices in other computing devices.

User interface input devices 822 can include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computing device 810 or onto a communication network.

User interface output devices 820 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 810 to the user or to another machine or computing device.

Storage subsystem 824 stores programming and data constructs that provide the functionality of some or all of the modules described herein. For example, the storage subsystem 824 may include the logic to perform selected aspects of one or more methods described herein.

These software modules are generally executed by processor 814 alone or in combination with other processors. Memory 825 used in the storage subsystem 824 can include a number of memories including a main random access memory (RAM) 830 for storage of instructions and data during program execution and a read only memory (ROM) 832 in which fixed instructions are stored. A file storage subsystem 826 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 826 in the storage subsystem 824, or in other machines accessible by the processor(s) 814.

Bus subsystem 812 provides a mechanism for letting the various components and subsystems of computing device 810 communicate with each other as intended. Although bus subsystem 812 is shown schematically as a single bus, alternative implementations of the bus subsystem may use multiple busses.

Computing device 810 can be of varying types including a workstation, server, computing cluster, blade server, server farm, or any other data processing system or computing device. Due to the ever-changing nature of computers and networks, the description of computing device 810 depicted in FIG. 8 is intended only as a specific example for purposes of illustrating some implementations. Many other configurations of computing device 810 are possible having more or fewer components than the computing device depicted in FIG. 8.

In some implementations, a method implemented by one or more processors is provided and includes, at each of a plurality of iterations of controlling a robot in attempting performance of a robotic task: processing a corresponding current first sensor data instance, using a first modality action machine learning (ML) model, to generate corresponding first predicted action output; processing a corresponding current second sensor data instance, using a second modality action ML model, to generate corresponding second predicted action output; comparing: (a) a corresponding first intermediate embedding generated using the first modality action ML model in generating the corresponding first predicted action output, and (b) a corresponding second intermediate embedding generated using the second modality action ML model in generating the corresponding second predicted action output; selecting, based on the comparing, either the corresponding first predicted action output or the corresponding second predicted action output; and controlling the robot using the selected one of the corresponding first predicted action output or the corresponding second predicted action output. The corresponding first sensor data instance is in a first modality and is generated by one or more first sensors of a plurality of sensors of a robot. The corresponding second sensor data instance is in a second modality is distinct from the first modality and that is generated by one or more of the sensors of a robot

These and other implementations of the technology disclosed herein can optionally include one or more of the following features.

In some implementations, the corresponding first predicted action outputs are utilized in a first subset of the iterations and the corresponding second predicted action outputs are utilized in a second subset of the iterations.

In some implementations, a method implemented by one or more processors is provided and includes obtaining a first sensor data instance that is in a first modality and that is generated by one or more first sensors of a plurality of sensors of a robot. The method further includes processing, using a first modality action ML model trained for controlling the robot to perform a robotic task based on sensor data in the first modality, the first sensor data instance to generate first predicted action output. Processing the first sensor data instance includes: generating a first embedding by processing the first sensor data instance using first initial layers of the first modality action ML model; and processing the first embedding using first additional layers of the first modality action ML model to generate the first predicted action output. The method further includes obtaining a second sensor data instance that is in a second modality that is distinct from the first modality and that is generated by one or more of the sensors of a robot. The method further includes processing, using a second modality action ML model trained for controlling the robot to perform the robotic task based on sensor data in the second modality, the second sensor data instance to generate second predicted action output. Processing the second sensor data instance includes: generating a second embedding by processing the second sensor data instance using second initial layers of the second modality action ML model; and processing the second embedding using second additional layers of the second modality action ML model to generate the second predicted action output. The method further includes determining, based on analysis of the first embedding and the second embedding, a first weight for the first predicted action output and a second weight for the second predicted action output. The method further includes determining a final predicted action output using the first weight and the second weight. The method further includes controlling the robot, using the final predicted action output, in an iteration of attempting a performance of the robotic task.

These and other implementations of the technology disclosed herein can optionally include one or more of the following features.

In some implementations, determining, based on analysis of the first embedding and the second embedding, the first weight and the second weight includes: determining the first weight as one and the second weight as zero. In some of those implementations, determining the final predicted action output includes using the second predicted action output as the final predicted action output responsive to determining the first weight as one and the second weight as zero.

In some implementations, determining, based on analysis of the first embedding and the second embedding, the first weight and the second weight includes: determining the first weight as a first value between zero and one and the second weight as a second value between zero and one. In some versions of those implementations, determining the final predicted action output includes determining the final predicted action output as a function of: the first predicted action output and the first weight, and the second predicted action output and the second weight. In some of those versions, determining the final predicted output as the function of the first predicted action output and the first weight, and the second predicted action output and the second weight includes: determining the final predicted action output as a weighted average of the first predicted action output and the second predicted action output. The weighted average weights the first predicted action output based on the first weight and weights the second predicted action output based on the second weight.

In some implementations, the first embedding is a first stochastic embedding parameterizing a first multivariate distribution and the second embedding is a second stochastic embedding parameterizing a second multivariate distribution. In some versions of those implementations, determining, based on analysis of the first embedding and the second embedding, the first weight and the second weight includes: determining the first weight as a function of first covariances of the first multivariate distribution and determining the second weight as a function of second covariances of the second multivariate distribution. In some of those versions, determining, based on analysis of the first embedding and the second embedding, the first weight and the second weight includes: determining the first weight as one and the second weight as zero responsive to the first covariances indicating a greater extent of variance than the second covariances.

In some implementations, the method further includes, subsequent to controlling the robot using the final predicted action output but prior to completion of the iteration of attempting performance of the robotic task: obtaining an additional first sensor data instance that is in the first modality and that is generated, by the one or more first sensors, subsequent to controlling the robot using the final predicted action output; processing, using the first modality action ML model, the additional first sensor data instance to generate an additional first predicted action output, where processing the additional first sensor data instance includes: generating an additional first embedding by processing the additional first sensor data instance using the first initial layers, and processing the additional first embedding using first additional layers to generate the additional first predicted action outputs; obtaining an additional second sensor data instance that is in a second modality that is distinct from the first modality and that is generated subsequent to controlling the robot using the final predicted action outputs; processing, using the second modality action ML model, the additional second sensor data instance to generate one or more additional second predicted action outputs, where processing the additional second sensor data instance includes: generating an additional second embedding by processing the additional second sensor data instance using the second initial layers, and processing the additional second embedding using second additional layers to generate the additional second predicted action outputs; determining, based on analysis of the additional first embedding and the additional second embedding, an additional first weight for the additional first predicted action outputs and an additional second weight for the additional second predicted action outputs, where the additional first weight differs from the first weight and where the additional second weight differs from the second weight; determining, based on analysis of the first embedding and the second embedding, an additional first weight for the first predicted action output and an additional second weight for the second predicted action output, where the additional first weight differs from the first weight and wherein the additional second weight differs from the second weight; determining an additional final predicted action output using the additional first weight and the additional second weight; and controlling the robot, using the additional final predicted action output, in an additional iteration of attempting a performance of the robotic task. In some of those implementations, the first weight is zero, the second weight is one, the additional first weight is one, and the additional second weight is zero.

In some implementations, the first sensor data instance is an RGB image that includes red, green, and blue channels, but lacks any depth channel, and wherein the first modality is an RGB modality.

In some implementations, the second sensor data instance is a depth image that includes a depth channel and wherein the second modality is a depth modality.

In some implementations, the first modality is a first vision modality that includes one or more color channels and the second modality is a second vision modality that lacks the one or more color channels.

In some implementations, the first modality is a first vision modality that includes one or more hyperspectral channels and the second modality is a second vision modality that lacks the one or more hyperspectral channels.

In some implementations, the first modality is a first vision modality that includes one or more thermal channels and the second modality is a second vision modality that lacks the one or more thermal channels.

In some implementations, the first modality is a first vision modality that includes one or more depth channels and the second modality is a second vision modality that lacks the one or more depth channels.

In some implementations, the one or more of the sensors that generate the second sensor data instance exclude any of the one or more first sensors.

In some implementations, the first additional layers include a first first component control head and a first second component control head, the first predicted action output include a first first component set of values for controlling a first robotic component of the robot, the second predicted action output includes a first second component set of values for controlling a second robotic component of the robot, the second additional layers include a second first component control head and second first second component control head, the first predicted action output includes a second first component set of values for controlling the first robotic component, and the second predicted action output includes a first second component set of values for controlling the second robotic component. In some of those implementations, the first robotic component is one of a robot arm, a robot end effector, a robot base, or a robot head and/or the second robotic component is another one of the robot arm, the robot end effector, the robot base, or the robot head.

What is claimed is:

1. A method implemented by one or more processors, the method comprising:
obtaining a first sensor data instance that is in a first modality and that is generated by one or more first sensors of a plurality of sensors of a robot;
processing, using a first modality action machine learning (ML) model trained for controlling the robot to perform a robotic task based on sensor data in the first modality, the first sensor data instance to generate first predicted action output, wherein processing the first sensor data instance comprises:
generating a first embedding by processing the first sensor data instance using first initial layers of the first modality action ML model; and
processing the first embedding using first additional layers of the first modality action ML model to generate the first predicted action output;
obtaining a second sensor data instance that is in a second modality that is distinct from the first modality and that is generated by one or more of the sensors of a robot;
processing, using a second modality action ML model trained for controlling the robot to perform the robotic task based on sensor data in the second modality, the second sensor data instance to generate second predicted action output, wherein processing the second sensor data instance comprises:
generating a second embedding by processing the second sensor data instance using second initial layers of the second modality action ML model; and
processing the second embedding using second additional layers of the second modality action ML model to generate the second predicted action output;
determining, based on analysis of the first embedding and the second embedding, a first weight for the first predicted action output and a second weight for the second predicted action output;
determining a final predicted action output using the first weight and the second weight; and
controlling the robot, using the final predicted action output, in an iteration of attempting a performance of the robotic task.

2. The method of claim 1,
wherein determining, based on analysis of the first embedding and the second embedding, the first weight and the second weight comprises:
determining the first weight as one and the second weight as zero; and
wherein determining the final predicted action output comprises:
using the second predicted action output as the final predicted action output responsive to determining the first weight as one and the second weight as zero.

3. The method of claim 1,
wherein determining, based on analysis of the first embedding and the second embedding, the first weight and the second weight comprises:
determining the first weight as a first value between zero and one and the second weight as a second value between zero and one; and
wherein determining the final predicted action output comprises:
determining the final predicted action output as a function of:
the first predicted action output and the first weight, and
the second predicted action output and the second weight.

4. The method of claim 3, wherein determining the final predicted output as the function of the first predicted action output and the first weight, and the second predicted action output and the second weight comprises:
determining the final predicted action output as a weighted average of the first predicted action output and the second predicted action output, the weighted average weighting the first predicted action output based on the first weight and weighting the second predicted action output based on the second weight.

5. The method of claim 1, wherein the first embedding is a first stochastic embedding parameterizing a first multivariate distribution and wherein the second embedding is a second stochastic embedding parameterizing a second multivariate distribution.

6. The method of claim 5, wherein determining, based on analysis of the first embedding and the second embedding, the first weight and the second weight comprises:
determining the first weight as a function of first covariances of the first multivariate distribution and determining the second weight as a function of second covariances of the second multivariate distribution.

7. The method of claim 5, wherein determining, based on analysis of the first embedding and the second embedding, the first weight and the second weight comprises:
determining the first weight as one and the second weight as zero responsive to the first covariances indicating a greater extent of variance than the second covariances.

8. The method of claim 1, further comprising, subsequent to controlling the robot using the final predicted action output but prior to completion of the iteration of attempting performance of the robotic task:
obtaining an additional first sensor data instance that is in the first modality and that is generated, by the one or more first sensors, subsequent to controlling the robot using the final predicted action output;
processing, using the first modality action ML model, the additional first sensor data instance to generate an additional first predicted action output, wherein processing the additional first sensor data instance comprises:
generating an additional first embedding by processing the additional first sensor data instance using the first initial layers; and
processing the additional first embedding using first additional layers to generate the additional first predicted action outputs;
obtaining an additional second sensor data instance that is in a second modality that is distinct from the first modality and that is generated subsequent to controlling the robot using the final predicted action outputs;
processing, using the second modality action ML model, the additional second sensor data instance to generate one or more additional second predicted action outputs, wherein processing the additional second sensor data instance comprises:
generating an additional second embedding by processing the additional second sensor data instance using the second initial layers; and
processing the additional second embedding using second additional layers to generate the additional second predicted action outputs;
determining, based on analysis of the additional first embedding and the additional second embedding, an additional first weight for the additional first predicted action outputs and an additional second weight for the additional second predicted action outputs,
wherein the additional first weight differs from the first weight and wherein the additional second weight differs from the second weight;
determining, based on analysis of the first embedding and the second embedding, an additional first weight for the first predicted action output and an additional second weight for the second predicted action output,
wherein the additional first weight differs from the first weight and wherein the additional second weight differs from the second weight;
determining an additional final predicted action output using the additional first weight and the additional second weight; and
controlling the robot, using the additional final predicted action output, in an additional iteration of attempting a performance of the robotic task.

9. The method of claim 8, wherein the first weight is zero, the second weight is one, the additional first weight is one, and the additional second weight is zero.

10. The method of claim 1, wherein the first sensor data instance is an RGB image that includes red, green, and blue channels, but lacks any depth channel, and wherein the first modality is an RGB modality.

11. The method of claim 10, wherein the second sensor data instance is a depth image that includes a depth channel and wherein the second modality is a depth modality.

12. The method of claim 1, wherein the first modality is a first vision modality that includes one or more color channels and wherein the second modality is a second vision modality that lacks the one or more color channels.

13. The method of claim 1, wherein the first modality is a first vision modality that includes one or more hyperspectral channels and wherein the second modality is a second vision modality that lacks the one or more hyperspectral channels.

14. The method of claim 1, wherein the first modality is a first vision modality that includes one or more thermal channels and wherein the second modality is a second vision modality that lacks the one or more thermal channels.

15. The method of claim 1, wherein the first modality is a first vision modality that includes one or more depth channels and wherein the second modality is a second vision modality that lacks the one or more depth channels.

16. The method of claim 1, wherein the one or more of the sensors that generate the second sensor data instance exclude any of the one or more first sensors.

17. The method of claim 1,
wherein the first additional layers comprise a first first component control head and a first second component control head,
wherein the first predicted action output comprises a first first component set of values for controlling a first robotic component of the robot, and
wherein the second predicted action output comprises a first second component set of values for controlling a second robotic component of the robot wherein the second additional layers comprise a second first component control head and second first second component control head,
wherein the first predicted action output comprises a second first component set of values for controlling the first robotic component, and
wherein the second predicted action output comprises a first second component set of values for controlling the second robotic component.

18. The method of claim 17,
wherein the first robotic component is one of a robot arm, a robot end effector, a robot base, or a robot head; and
wherein the second robotic component is another one of the robot arm, the robot end effector, the robot base, or the robot head.

19. A method implemented by one or more processors of a robot, the method comprising:
at each of a plurality of iterations of controlling the robot in attempting performance of a robotic task:
processing a corresponding current first sensor data instance, using a first modality action machine learning (ML) model, to generate corresponding first predicted action output,
wherein the corresponding first sensor data instance is in a first modality and is generated by one or more first sensors of a plurality of sensors of a robot;
processing a corresponding current second sensor data instance, using a second modality action ML model, to generate corresponding second predicted action output,
wherein the corresponding second sensor data instance is in a second modality is distinct from the first modality and that is generated by one or more of the sensors of a robot;
comparing:
a corresponding first intermediate embedding generated using the first modality action ML model in generating the corresponding first predicted action output, and
a corresponding second intermediate embedding generated using the second modality action ML model in generating the corresponding second predicted action output;
selecting, based on the comparing, either the corresponding first predicted action output or the corresponding second predicted action output; and
controlling the robot using the selected one of the corresponding first predicted action output or the corresponding second predicted action output.

20. The method of claim 19, wherein the corresponding first predicted action outputs are utilized in a first subset of the iterations and wherein the corresponding second predicted action outputs are utilized in a second subset of the iterations.
